(19) United States
(12) Patent Application Publication
(10) Pub. No.: US 2017/0297261 A1
(43) Pub. Date: Oct. 19, 2017

(54) METHOD AND SYSTEM FOR PRODUCING A THREE-DIMENSIONAL OBJECT

(71) Applicant: Schultheiss GmbH, Heimsheim (DE)

(72) Inventors: Andreas Schultheiss, Heimsheim (DE); Andreas Geitner, Leonberg (DE)

(21) Appl. No.: 15/440,146

(22) Filed: Feb. 23, 2017

(30) Foreign Application Priority Data
Feb. 23, 2016 (DE) 10 2016 103 186

(51) Int. Cl. B29C 64/129; B33Y 50/02; B29C 64/286; B33Y 10/00; B29C 64/393; B33Y 30/00

(52) U.S. Cl. CPC B29C 64/129; B29C 64/393; B33Y 30/00; B29C 64/286; B33Y 10/00; B33Y 50/02; B29K 2909/08; B29K 2995/0026

(57) ABSTRACT

The invention relates to a system for producing a three-dimensional object by solidifying layer by layer a material that can be solidified under the effect of radiation. The system comprises a device for releasing a material layer of the solidifiable material that has solidified on a carrier defining a reference surface from the carrier. The device comprises a flexible elastic release element. The release element is arranged between the carrier and the material layer and can be detached nondestructively from the carrier. The system also comprises a fluid introduction device for introducing a release fluid between the carrier and the release element. The reference surface is curved in a way deviating from a plane.

### CROSS-REFERENCE TO RELATED APPLICATIONS

This application claims the benefit of German application No. 10 2016 103 186.0 filed on Feb. 23, 2016, which is incorporated herein by reference in its entirety and for all purposes.

### FIELD OF THE INVENTION

The present invention relates to systems for producing a three-dimensional object generally, and more specifically to a system for producing a three-dimensional object by solidifying layer by layer a material that can be solidified under the effect of radiation, which system comprises a device for releasing a material layer of the solidifiable material that has solidified on a carrier defining a reference surface from the carrier, which device comprises a flexible elastic release element, which release element is arranged between the carrier and the material layer and can be detached nondestructively from the carrier, the system also comprising a fluid introduction device for introducing a release fluid between the carrier and the release element.

The present invention also relates to methods for producing a three-dimensional object generally, and more specifically to a method for producing a three-dimensional object by solidifying layer by layer a material that can be solidified under the effect of radiation, in which a material layer of the solidifiable material that has solidified on a carrier defining a reference surface is released from the carrier, a flexible elastic release element being arranged between the carrier and the material layer and being detached nondestructively from the carrier by introducing a release fluid between the carrier and the release element.

### BACKGROUND OF THE INVENTION

Systems and methods of the type described in the introduction are known for example from EP 1 439 052 B1.

One particular problem with these methods is that the release element and the carrier lie against one another with full surface-area contact. If there are inclusions of air between the release element and the carrier, this can in particular have undesired effects on an exposure of the solidifiable material in the sense that not the desired layer pattern but a deformed layer pattern, of a deviant form because of the inclusion, is produced in the solidifiable material. As a consequence of this, the actual form of the three-dimensional object to be produced may then deviate significantly from the desired form. This may have great effects particularly in the case of small structures of the three-dimensional object to be produced.

The cause of a deviation resulting from an inclusion is in particular that, in order to cure the solidifiable material, the radiation has to radiate not only through the carrier and the release element but also through air inclusions, which have the effect of an optical element, in particular a lens. This has the consequence that not just three interfaces have to be taken into account for the transmission of the radiation, that is to say into the carrier, from the carrier into the release element and from the release element into the material to be solidified, but altogether four interfaces, that is to say into the carrier, out of the carrier into the air inclusion between the carrier and the release element, from the inclusion into the release element and from the release element into the material to be solidified.

### SUMMARY OF THE INVENTION

In a first aspect of the invention, a system is provided for producing a three-dimensional object by solidifying layer by layer a material that can be solidified under the effect of radiation. The system comprises a device for releasing a material layer of the solidifiable material that has solidified on a carrier defining a reference surface from the carrier. The device comprises a flexible elastic release element. The release element is arranged between the carrier and the material layer and can be detached nondestructively from the carrier. The system also comprises a fluid introduction device for introducing a release fluid between the carrier and the release element. The reference surface is curved in a way deviating from a plane.

In a second aspect of the invention, a method is provided for producing a three-dimensional object by solidifying layer by layer a material that can be solidified under the effect of radiation. A material layer of the solidifiable material that has solidified on a carrier defining a reference surface is released from the carrier. A flexible elastic release element is arranged between the carrier and the material layer and is detached nondestructively from the carrier by introducing a release fluid between the carrier and the release element. The reference surface is provided as a reference surface that is curved in a way deviating from a plane.

### BRIEF DESCRIPTION OF THE DRAWINGS

The foregoing summary and the following description may be better understood in conjunction with the drawing figures, of which:

FIG. 1 shows a schematic representation of part of a system for producing a three-dimensional object;

FIG. 2 shows a schematic representation of part of a second exemplary embodiment of a system for producing a three-dimensional object;

FIG. 3 shows a sectional view of an exemplary embodiment of a holding device for a carrier with a placed-on container for material to be solidified;

FIG. 4 shows an enlarged partial view of the sectional view from FIG. 3;

FIG. 5 shows a schematic perspective view of the arrangement from FIG. 3 without the carrier and the release element;

FIG. 6 shows an enlarged partial view of the arrangement from FIG. 5;

FIG. 7 shows a schematic sectional view of a system according to the invention with a curved carrier;

FIG. 8 shows a sectional view similar to FIG. 7 with the release element lifted off from the carrier;

FIG. 9 shows a schematic representation of the layer structure of a three-dimensional object during production with a system comprising a carrier with a curved reference surface;

FIG. 10 shows a schematic representation of a sequence of successive steps for solidifying a material layer;

FIG. 11 shows a schematic sectional view through a carrier, a release element and the object to be produced directly after the solidifying of a material layer; and

FIG. 12 shows a schematic view similar to FIG. 11 after lifting off of the release element from the carrier before applying a negative pressure between the release element and the carrier.

### DETAILED DESCRIPTION

Although the invention is illustrated and described herein with reference to specific embodiments, the invention is not intended to be limited to the details shown. Rather, various modifications may be made in the details within the scope and range of equivalents of the claims and without departing from the invention.

The present invention relates to a system for producing a three-dimensional object by solidifying layer by layer a material that can be solidified under the effect of radiation, which system comprises a device for releasing a material layer of the solidifiable material that has solidified on a carrier defining a reference surface from the carrier, which device comprises a flexible elastic release element, which release element is arranged between the carrier and the material layer and can be detached nondestructively from the carrier, the system also comprising a fluid introduction device for introducing a release fluid between the carrier and the release element, wherein the reference surface is curved in a way deviating from a plane.

Forming the reference surface in the way described has several advantages. On the one hand, when there is a movement of the release element and the carrier towards one another, the release element can for example first come into contact with the farthest pre-curved region of the surface area of the carrier. Only with further movement of the carrier and the release element towards one another can the flexible elastic release element then successively come to bear snugly against the carrier. In this way, undesired inclusions between the carrier and the release element can be avoided completely or substantially completely. By contrast with this, in the case of a planar reference surface, the forming of inclusions is virtually unavoidable. Even if its curvature is very small, or its radius of curvature is very great, a curved reference surface is already sufficient to avoid the disadvantages that a carrier with a planar surface serving as a reference has, including therefore a planar or flat reference surface such as that known from the prior art.

It is advantageous if the reference surface is curved one-dimensionally or two-dimensionally. Two-dimensionally, it may be curved in particular to form a segment of a surface of an ellipsoid. One-dimensionally, it could for example be the surface of an elongated parabolic cylinder. A two-dimensionally curved reference surface has the advantage that, when they move towards one another, the flexible elastic release element contacts the carrier at a projecting point or region and then, starting from the first contact, can come to bear snugly against the carrier with full surface-area contact. A one-dimensionally curved reference surface makes it possible for the release element to bear against the carrier in the form of a line or strip when it first comes into contact with the same, in order, starting from the contact line or the contact strip, to achieve bearing of the release element and the carrier against one another with full surface-area contact.

It is favourable if the reference surface defines a segment of a curved surface of a straight circular cylinder or a segment of an ellipsoid surface. In particular, the ellipsoid surface may take the form of a spherical surface. Such reference surfaces can be produced in an easy way, for example by clamping a flat glass sheet in a frame.

It is advantageous if the reference surface has a radius of curvature in a range from approximately 1 m to approximately 100 m. In particular, the radius of curvature may lie in a range from approximately 10 m to approximately 50 m. Such a radius of curvature range is obtained approximately for a width of the carrier of 0.5 m with a difference in curvature of approximately 0.3 to 0.5 mm. That corresponds approximately to three to five cured material layers over the entire area of the carrier.

In order to make it possible for the release element to bear snugly against the curved carrier with full surface-area contact, it is advantageous if the release element takes the form of a flexible elastic film.

The release element can be formed in a particularly low-cost manner if the film takes the form of a membrane. In this way, the release element can be of a particularly thin, elastic and flexible form.

According to a further preferred embodiment of the invention, it may be provided that the system comprises a container for the solidifiable material and that the release element forms a bottom or part of a bottom or a top of the container. This allows a very compact system to be formed. Then, in an exposure position, the release element can be in contact with the carrier, preferably with full surface-area contact without inclusions, on its one side and be in contact with the solidifiable material on the other side. The solidifiable material may be in particular a liquid polymer, which cures by being subjected to electromagnetic radiation, for example UV light. If it is formed in such a way that the release element forms the bottom, the container is subjected to radiation from below, that is to say through the bottom. If the release element forms the top of the container, the solidifiable material is subjected to radiation from above.

The system can be formed in a way that is particularly stable and easy to handle if the container comprises a peripheral frame and if the release element is arranged or formed on the frame. For example, the peripheral frame may have a through-opening, which is closed or can be closed by the release element, depending on whether the release element forms the bottom or a top of the container. The container may in particular take the form of a shallow tray. The frame may form a wall of the container and in particular have a height that is less, in particular much less, than a length of the sides of the frame.

The carrier can be arranged in an simple way if the system comprises a holding device for holding the carrier. For example, the holding device may be formed in such a way that the carrier is held in an undeformed state, that is to say without forces being exerted on the carrier by the holding device. Alternatively, the holding device may also be formed in such a way that the carrier is deformed in the holding device. Such a holding device is then formed so as to exert holding forces on the carrier.

It is advantageous if the holding device comprises supporting projections of different heights for supporting the carrier. This makes it possible in particular to place a flat carrier in sheet form, for example a sheet of glass or sheet of plastic, onto the supporting projections and, by clamping the carrier along a peripheral edge thereof, deform it in such a way that it is one-dimensionally or two-dimensionally curved.

It is favourable if the holding device has a fluid channel, which is in particular formed peripherally. Such a fluid channel makes it possible to conduct a release fluid between the release element and the carrier or remove it again from there, so that the release element and the carrier bear against one another directly without release fluid in between.

It is advantageous if the fluid channel is closed fluid-tightly when, in an exposure position in which the solidifiable material is subjected to radiation, the release element bears against the carrier, in particular with full surface-area contact. For example, a vacuum may be applied by way of the fluid-tight fluid channel in order to suck the release element against the carrier.

In order to introduce a release fluid between the release element and the carrier or remove it from between them in an easy way, it is advantageous if the release element and/or the carrier define part of an inner delimiting surface of the fluid channel.

The system can be formed particularly compactly if the holding device defines part of an inner delimiting surface of the fluid channel. In particular, the fluid channel may be formed on the holding device or substantially on the holding device.

In order to be able to move the release element and the carrier in relation to one another in an easy way, it is advantageous if the frame defines part of an inner delimiting surface of the fluid channel. For example, whenever the release element bears completely against the carrier, the frame may thus define part of the fluid channel.

In order that sealing off of the fluid channel is made possible as easily as possible, it is advantageous if the release element projects beyond the carrier at least on one side. It preferably projects beyond the carrier on more than one side or on all sides.

In order to be able in particular to seal off the fluid channel fluid-tightly, it is favourable if at least a first sealing element is arranged or formed between the carrier and the holding device. For example, this may be a peripheral sealing element in the form of a sealing ring, which is placed into a recess on the holding device and projects somewhat from it in order to bear against the carrier with surface-area contact.

It is also advantageous for sealing off the fluid channel if the system comprises a second sealing element, arranged between the holding device and the frame. For example, the sealing element may be attached either to the holding device or to the frame. If the frame moves in relation to the holding device, for example away from it, the sealing element may then no longer be in contact with the frame, so that the fluid channel is opened. When there is a movement of the frame and the holding device towards one another, the second sealing element may then seal off the holding device and the frame in relation to one another. The second sealing element may also be formed peripherally, in particular in the form of a sealing ring.

The system can be formed and handled particularly simply if the second sealing element is arranged or formed on the holding device or on the frame.

A reference surface can be formed in an simple way if the carrier takes the form of a sheet of glass. This has sufficient stability and, when in a basic position it defines a flat reference surface, can be deformed in an easy way such that a surface of the sheet of glass defines a curved reference surface. This can be achieved for example by clamping the sheet of glass on the holding device.

Favourably, the fluid introduction device is connected fluidically to the fluid channel. This makes it possible when the fluid channel is sealed off fluid-tightly to introduce release fluid between the release element and the carrier, or conversely also remove it again, for example by sucking or pumping it away.

It is advantageous if the system comprises a pumping device for pumping away the release fluid between the release element and the carrier. The pumping device may serve in particular for generating a negative pressure for pumping or sucking away the release fluid, in particular by way of the fluid channel. For this purpose, the pumping device may be connected fluidically to the fluid channel.

The fluid introduction device may in particular take the form of an venting valve, in order for example to allow release fluid to flow into an evacuated fluid channel, so that the release fluid can flow between the release element and the carrier.

In order to exert a higher force on the release element with the release fluid, for example in order to detach it from the carrier in an easy way and quickly, it is advantageous if the fluid introduction device is formed so as to introduce the release fluid between the release element and the carrier under positive pressure. Depending on the configuration of the release element and the fluid channel, positive pressures of up to 0.5 bar, in particular also up to 1 bar, can be applied here.

A release element bearing against the carrier can be separated from the latter in a particularly easy way by pumping away if the system has an venting device for introducing the release medium between the release element and the carrier. For example, the venting device may comprise a valve for connecting the fluid channel fluidically to a surrounding area of the system. If a negative pressure initially prevails in the fluid channel, ambient air automatically flows in through the venting device when the valve is opened in order to create a pressure equalization.

The venting device can be formed in a particularly easy way if it comprises at least one venting valve.

The system can be formed particularly compactly if the fluid introduction device comprises the venting device. For example, the fluid introduction device may comprise a fluid pump in which the venting device is integrated, for example in the form of an venting valve.

The system can be handled particularly easily if the release fluid is a liquid or a gas. In particular, the release fluid may be water or air. The release fluid is preferably air, so that the system can be operated with ambient air as the release fluid. No particular measures have to be taken for this; in particular, no storage container has to be provided for the release fluid.

It is advantageous if the system comprises a lifting device for moving the release element and the carrier in relation to one another. In particular, the lifting device may be formed so as to make a movement of the release element and the carrier in relation to one another possible in a direction transverse, in particular perpendicular, to the reference surface. Thus, with the lifting device, the release element can in particular be lifted off from the carrier. This is favourable because, after the lifting off of the release element from the carrier, in a second step the release element that is adhering to the last-cured material layer can be pulled off or peeled off from it in an easy way. This would not be possible if the release element and the carrier were still bearing against one another with full surface-area contact.

It is advantageous if the lifting device is formed so as to raise and lower the release element. Thus, the holding device can be formed particularly stably, in order to preset a defined reference surface by the carrier.

The release element can be moved in relation to the holding device particularly easily if the lifting device is formed so as to raise and lower the frame. The release element may then be jointly raised together with the frame on which it is optionally arranged.

It is advantageous if the system comprises a pressure measuring device for measuring a pressure prevailing between the release element and the carrier. For example, such a pressure measuring device makes it possible to activate and/or control the fluid introduction device and/or the pumping device and/or the lifting device in dependence on the measured pressure.

It may also be favourable if the system comprises a force measuring device for measuring a force acting on the carrier. Optionally, with the force measuring device or a further force measuring device, a force acting between the release element and the last-cured material layer adhering thereto may also be provided. The said force measuring devices may in particular take the form of force measuring sensors. With them, forces can be measured, in particular a force acting when detaching the release element from the last-cured material layer, in order for example, depending on this, to activate the lifting device and/or the fluid introduction device. This may take place in particular when the release element is separated from the carrier and a negative pressure is generated between the release element and the carrier by the pumping device in order to detach the release element from the last-cured material layer.

According to a further preferred embodiment of the invention, it may be provided that the system comprises an open-loop and/or closed-loop control device for controlling the fluid introduction device and/or the pumping device in an open-loop and/or closed-loop manner in dependence on a force acting on the carrier and/or in dependence on an exposure time and/or a curing time of the solidifiable material. In particular, successive steps for producing successively cured material layers can thus be preset in a simple and reliable way. In particular, with the open-loop and/or closed-loop control device, fully automatic operation of the system can take place.

It is advantageous if the open-loop and/or closed-loop control device is formed so as to control the lifting device in dependence on the force acting on the carrier that is measured by the force measuring device. For example, it can in this way be prevented that the lifting device is moved too quickly, whereby the release element or else the last-cured material layer or the already produced object could be damaged. In particular, the lifting device may be formed so as to move the carrier parallel to or counter to the direction of gravitational force.

It may also be favourable if the open-loop and/or closed-loop control device is formed so as to control the lifting device in dependence on the pressure prevailing between the release element and the carrier. For example, it can in this way be prevented that the lifting device is activated when there is a negative pressure prevailing between the release element and the carrier.

For curing the solidifiable material, it is advantageous if the system comprises an exposure device for exposing the solidifiable material layer by layer by subjecting it to radiation. The exposure device may in particular comprise a mask control, in order in each case to project a layer image of the next layer to be solidified into an image/building plane that is defined by the reference surface. In particular, the exposure device may comprise suitable optical elements such as lenses and mirrors.

It is also advantageous if the exposure device comprises at least one radiation source. The radiation source may be in particular a laser or a light-emitting diode or a halogen lamp or arrays of lasers or light-emitting diodes. In particular, the exposure device may comprise a projector in the form of a beamer.

The present invention further relates to a method for producing a three-dimensional object by solidifying layer by layer a material that can be solidified under the effect of radiation, in which a material layer of the solidifiable material that has solidified on a carrier defining a reference surface is released from the carrier, a flexible elastic release element being arranged between the carrier and the material layer and being detached nondestructively from the carrier by introducing a release fluid between the carrier and the release element, wherein the reference surface is provided as a reference surface that is curved in a way deviating from a plane.

As already mentioned, the curved reference surface makes it possible in a simple way to release the release element and the carrier from one another, in particular by introducing the release fluid between the release element and the carrier. Bringing the release element into contact with the carrier and bringing the release element to bear against the carrier with full surface-area contact is also made easier by the curved reference surface.

It is advantageous if the reference surface is curved one-dimensionally or two-dimensionally.

The release element can be brought to bear against the carrier with full surface-area contact particularly well if it takes the form of a flexible elastic film.

The method can be carried out particularly easily and in a particularly low-cost manner if the film takes the form of a membrane.

Three-dimensional objects can be produced in a way that is easy to handle if a container for the solidifiable material is provided and if the release element forms a bottom or part of a bottom or a top of the container.

The solidifiable material can be handled advantageously if the container comprises a peripheral frame and if the release element is arranged or formed on the frame. Thus, the container, for example in the form of a tray, and with it the release element, can be moved in an easy way in relation to the carrier.

The carrier is preferably held on a holding device. In particular, it may be held on the holding device only by the force of its own weight. Optionally, it may additionally be subjected to holding forces, for example in order to deform the carrier. For example, a sheet of glass that is flat in a basic position can thus be clamped on the holding device in an easy way, and thereby be deformed for presetting a curved reference surface.

It is advantageous if the carrier is placed onto supporting projections of the holding device for supporting the carrier. In particular, the supporting projections may differ in height. Thus, a carrier that is flat in a basic position can easily be deformed in a desired way to form a curved reference surface for curving, for example by clamping.

The holding device is preferably formed with a fluid channel, which in particular is formed peripherally. In particular, a peripheral formation of the fluid channel makes uniform introduction and removal of the release fluid possible.

In order to make possible in particular a negative pressure for sucking the release element against the carrier or bringing the release element to bear snugly against the carrier, it is advantageous if the fluid channel is closed fluid-tightly when, in an exposure position in which the solidifiable material is subjected to radiation, the release element bears against the carrier, in particular with full surface-area contact. It can in this way be prevented in particular when applying a negative pressure to the fluid channel that the release element can undesirably separate from the carrier.

It is advantageous if a negative pressure is generated between the release element and the carrier. This has on the one hand the advantage that, when it is close enough to the carrier, the release element can come to bear snugly against the carrier directly without forming inclusions. If the release element is kept sufficiently far away from the carrier, the generating of a negative pressure between the release element and the carrier can be used for peeling off the release element from the last-solidified material layer.

A negative pressure can be generated in an easy way if the release fluid is sucked away.

In order in particular to be able to generate a negative pressure between the release element and the carrier, it is advantageous if the carrier and the holding device are sealed off in relation to one another.

It may also be advantageous if the holding device and the frame are sealed off in relation to one another. In particular, in this way a space between the release element and the carrier can also be subjected to a negative pressure.

Favourably, the carrier is of a radiation-transmissive form. This makes it possible to radiate through the carrier to cure the curable material. In particular, the carrier may take the form of a sheet of glass.

In order to facilitate the detachment of the release element from the carrier, it is advantageous if for this purpose release fluid is introduced under pressure between the release element and the carrier. In particular, the pressure under which the release fluid is introduced between the release element and the carrier may be controlled quite specifically to accelerate a detaching operation and also to avoid the release element being damaged.

Without additional pumping devices, the release element can separate from the carrier when the release fluid is conducted between the release element and the carrier by admitting air. For example, by using a simple venting valve, air can be admitted again to a previously evacuated intermediate space between the release element and the carrier, so that the latter lie directly against one another, by filling with release fluid, for example ambient air.

The release fluid is preferably provided in the form of a liquid or a gas. In particular, it may be provided in the form of water or air. Air in particular is outstandingly suitable, since it is available in a sufficient amount, and therefore no additional reservoir has to be provided for the release fluid.

It is advantageous if the release element and the carrier are moved in relation to one another for releasing them from one another and for bringing them into contact with one another. For example, they may be moved in relation to one another in a direction transverse to the reference surface, in particular perpendicular to the reference surface. For example, it is favourable if the release element and the carrier are moved away from one another in order subsequently to separate the release element from the already solidified material layer. Once it is separated, the release element can then be brought to bear against the carrier again, for example by the release element and the carrier being moved towards one another again until the release element touches the carrier. In a next step, release fluid located between the release element and the carrier can be removed by applying a negative pressure, so that the release element and the carrier lie against one another with full surface-area contact. The already solidified material layers of the object to be produced are then positioned again in relation to the carrier such that, by irradiating the curable material that has flowed in between the last-solidified material layer and the release element, it is solidified by being subjected to radiation. Thus, in successive steps that are always the same, material layers can be cured in the desired number, shape and size to form the three-dimensional object. The frame is preferably raised and lowered with the lifting device. The frame may be formed so as to be more stable than the release element, so that it can also be coupled more easily to a lifting device, for example clamped into it or the like.

The pressure prevailing between the release element and the carrier is preferably measured. For example, the moving of the release element and the carrier away from one another or towards one another may be controlled depending on a measured pressure. For example, the release element is preferably not moved in relation to the carrier until the pressure goes below a preset minimum negative pressure. This allows undesired detachment of the release element from the last-solidified material layer to be prevented.

Preferably, a force acting on the carrier is measured. Optionally, a force acting on the release element may also be measured. For example, on the basis of the measured force, the detachment of the release element from the last-solidified layer may be specifically controlled, in order to avoid destruction of the already formed part of the object to be produced.

It is favourable if the release fluid is introduced between the release element and the carrier in dependence on a force acting on the carrier and/or in dependence on an exposure time and/or a curing time of the solidifiable material. In this way, the production of the three-dimensional object can be accelerated significantly, since the release element must only be held against the carrier until in particular the material layer to be solidified has cured. For example, the detachment of the release element from the carrier can be accelerated by introducing the release fluid between the release element and the carrier with positive pressure.

It may also be advantageous if the release element and the carrier are moved in relation to one another in dependence on a force acting on the carrier. In particular, the release element and the carrier may be moved in relation to one another in parallel or counter to the direction of gravitational force.

It is advantageous if, before the exposure of the solidifiable material to form a further cured material layer, the last-cured material layer is separated from the release element. This makes it possible in particular that solidifiable material can flow between the last-cured material layer and the release element and be cured in a next exposure step.

It is favourable if, before the separation of the release element from the material layer, the release element is first separated from the carrier. In particular, this may take place by moving the release element and the carrier away from one another. This procedure makes it possible in particular to separate the release element from the last-cured material layer by forming a negative pressure between the release element and the carrier. In particular, this may take place in dependence on a force, in particular in the form of a pulling force, which the release element exerts on the last-solidified material layer.

It is advantageous if, after the separation of the release element from the carrier, the release fluid between the release element and the carrier is removed, in particular by pumping away, for the separation of the release element by pulling off the last-solidified material layer. By applying the pressure, and in particular simultaneously measuring a force acting between the last-solidified material layer and the release element, damage, both to the already produced part of the three-dimensional object and to the release element, can be effectively prevented.

The removal of the release fluid is preferably controlled in an open-loop and/or closed-loop manner in dependence on a force acting between the release element and the last-solidified material layer. This takes place in particular to avoid damage to the release element and/or to the already solidified material layers for forming the three-dimensional object.

The solidifiable material can be attached in an easy way if an exposure device is provided for generating the radiation to expose the solidifiable material layer by layer. In particular, the exposure device may be provided with optical elements in order to project the generated radiation into the image/building plane defined by the reference surface.

Further, it is proposed to use of one of the systems for producing a three-dimensional object that have been described above for carrying out one of the methods described above for producing a three-dimensional object.

With one of the systems described, three-dimensional objects can be produced in an advantageous way, in particular if one of the methods described above with the advantages mentioned is carried out.

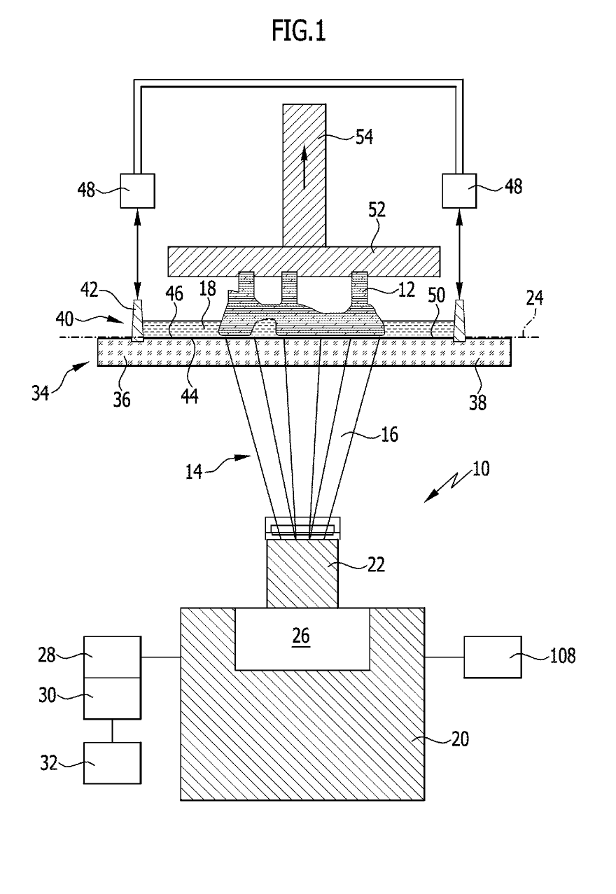

In FIG. 1, the structure of a system 10 for producing a three-dimensional object by solidifying layer by layer a material 18 that can be solidified under the effect of radiation 16 defining a radiation field 14 is illustrated by way of example.

The system 10 comprises in particular a radiation source 20, which comprises an imaging optical unit 22 for projecting an object layer image into an image/building plane 24, subsequently also referred to simply as a building plane. The imaging optical unit 22 includes a masking unit 26, which can be activated by an exposure mask generating device 28.

With the exposure mask generating device 28, in particular an exposure mask can be generated for each object layer of the object 12, to be precise for example in the form of a 2-bit bitmap. Each 2-bit bitmap therefore has merely two bit values, one bit value allowing a greater transmissivity for the radiation 16 than the other bit value. The one bit value for the radiation 16 may be completely “transmissive”, the other bit value for the radiation 16 may be completely “non-transmissive”. In any case, the transmissivities of the pixels of the 2-bit bitmap differ. Alternatively, instead of a two-bit bitmap, any other kind of exposure masks may also be used.

The exposure mask generating device 28 optionally comprises a memory device 30, which may for example contain stored items of native information for the object layers to be formed of the object 12 to be formed. These items may in particular be transferred to a computer 32 or some other computing device suitable for this. In dependence on the layer information, a 2-bit bitmap is calculated, for example with the computer 32, and then transferred to the masking unit 26, in order for example to activate an LCD display in the case of exposure in transmission or a digital micromirror device with at least one deflecting mirror, in order in this way to project the radiation 16 generated by the radiation source 20 onto the image/building plane 24 in a way corresponding to the object layer to be formed.

In the image/building plane 24, the radiation 16 is incident on still unsolidified, viscous material 18, which after a certain time, in dependence on the material and the radiation intensity, is solidified by the input of energy as a result of exposure. Optionally, an individual exposure time may be preset for each object layer, so that for example the masking unit 26 prevents the radiation 16 completely if no object layer is to be formed, and selectively allows the radiation 16 through if an object layer is to be formed.

In principle, two different types of arrangement of carrier systems 34 are used for the forming of objects 12. On a carrier 36, which takes the form of a transparent sheet of glass 38, there is placed a container 40 for the material 18 to be solidified. The container 40 comprises a peripheral frame 42, which is closed by a bottom 44, which forms a release element 46. The release element 46 takes the form of a flexible elastic membrane or a flexible elastic film.

With a schematically illustrated lifting device 48, the container 40 can be raised from the carrier 36 counter to the direction of gravitational force and lowered parallel to the direction of gravitational force.

The radiation source 20 is arranged under the carrier 36 in the direction of gravitational force and radiates through the sheet of glass 38 and the release element 46. The release element 46 is directly adjacent to the image/building plane 24. The carrier 36 defines a reference surface 50, which runs parallel to the image/building plane 24.

The three-dimensional object 12 adheres to a platform 52, which with a drive unit 54 moves the object 12 layer by layer counter to the direction of gravitational force out of the container 40 after the solidifying of each new material layer, for example by the thickness of a material layer.

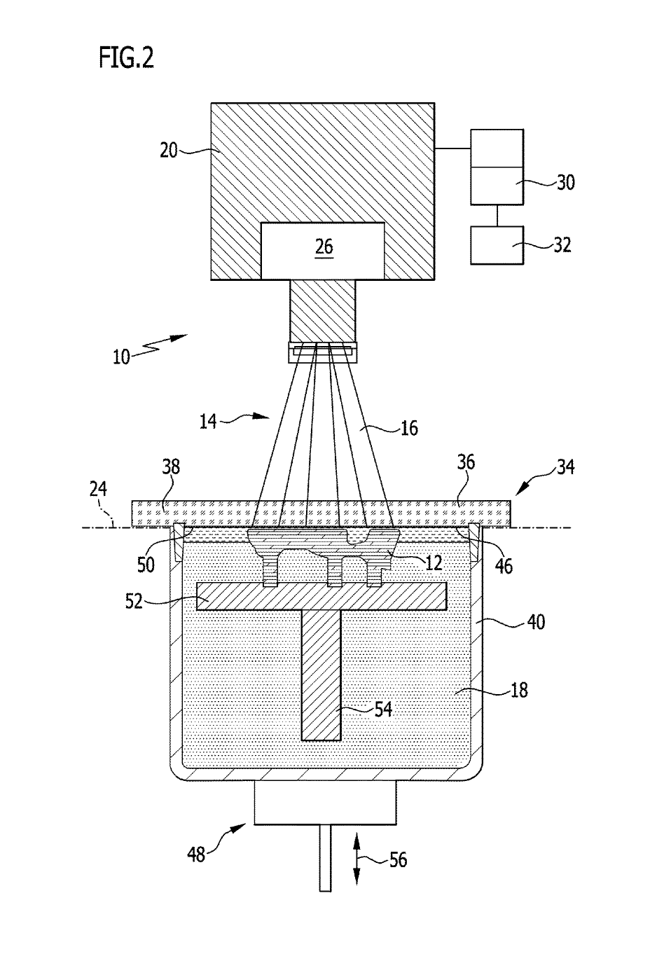

In FIG. 2, a variant of the system 10 containing substantially the same components is illustrated and provided with the same designations.

The system 10 from FIG. 2 differs from the system 10 from FIG. 1 substantially by the configuration of the carrier system 34. Here, the carrier in the form of the sheet of glass 38 is arranged above the container 40 in the direction of gravitational force. This container is completely filled with the material 18 to be solidified and is closed at the top by the release element 46. An underside of the sheet of glass 38 forms the reference surface 50. The release element 46 bears against the latter with surface-area contact or in the exposure position is sucked against it by negative pressure.

The three-dimensional object 12 to be produced is located completely within the viscous material 18 in the container 40 on a platform 52, which with a drive unit 54 can be moved layer by layer parallel to the direction of gravitational force away from the carrier 36, that is to say in a way corresponding to the thickness of a solidified layer.

The container 40 is arranged on a lifting device 48, which can move the container 40 as a whole in relation to the carrier 36, parallel to the direction of gravitational force and counter thereto, that is to say in a way corresponding to the depicted arrow 56.

In the case of the arrangement from FIG. 2, the carrier 36 is radiated through from above for solidifying a still liquid viscous layer of the material 18, which is located between the release element 46 and the last-solidified material layer of the object 12.

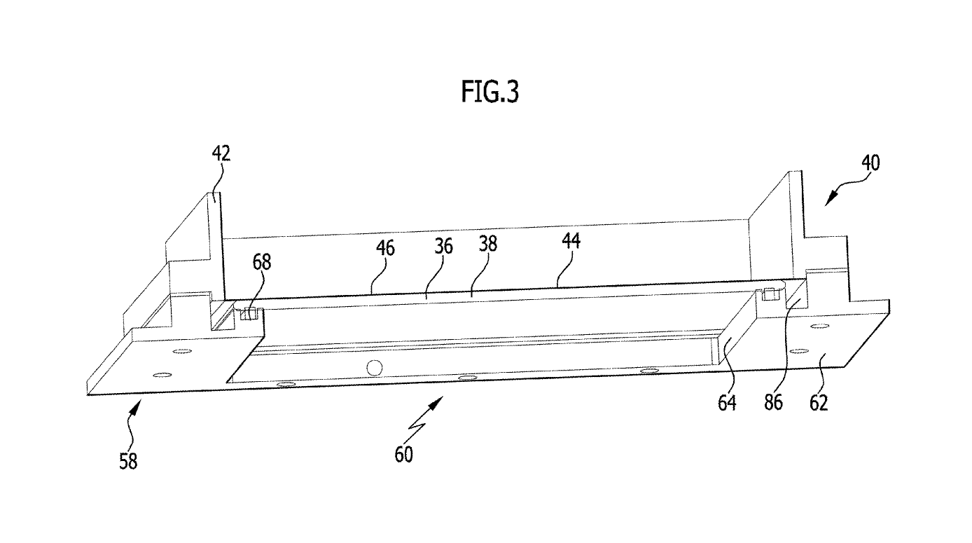

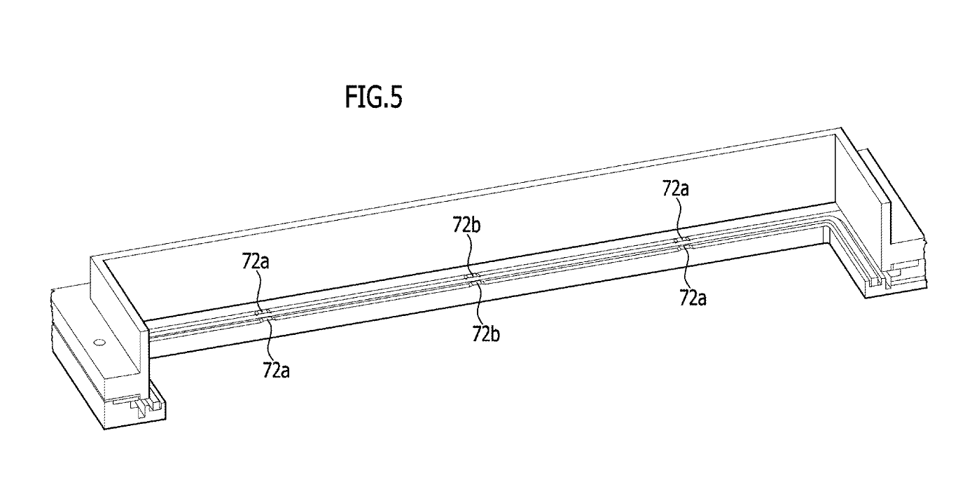

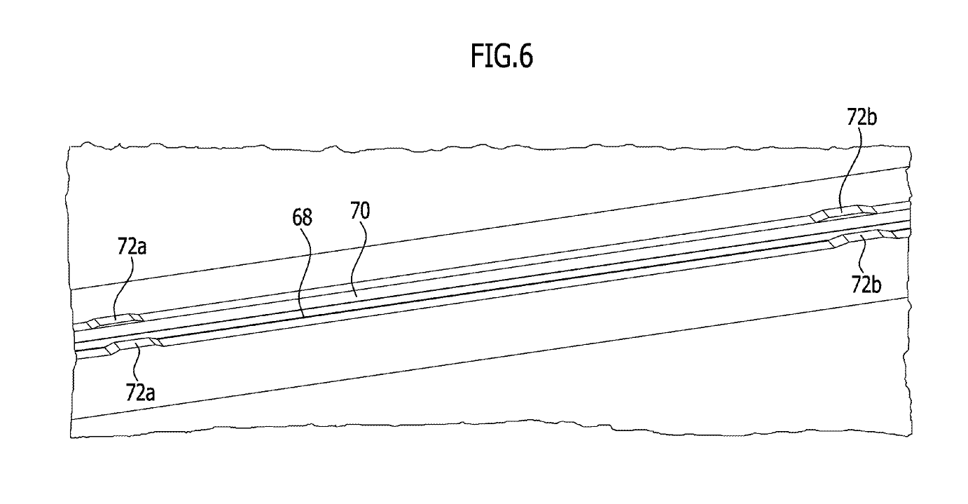

In FIGS. 3 to 6, a configuration of a container 40 with an associated holding device 58 is illustrated by way of example as an exchange unit 60 designated as a whole for the system 10 from FIG. 1.

The container 40 defines a peripheral frame 42, a lower opening of the frame 42 being closed by an elastic flexible carrier element 46 to form a bottom 44. Not yet solidified material 18 can be filled into the container 40 formed in such a way from above.

The holding device 58 likewise comprises a peripheral frame 62, which has a central window opening 64, which is closed at the top by the carrier 36 in the form of a sheet of glass 38. The sheet of glass 38 is supported on a peripheral projection 66 projecting counter to the direction of gravitational force. This projection is provided with a peripheral groove 68, which is open counter to the direction of gravitational force and inserted in which there is a peripheral sealing element 70.

On two opposite sides of the window opening 64, supporting projections 72a and 72b are integrally formed on the projections 66 on both sides of the groove 68, the supporting projections 72b projecting somewhat further beyond the projection 66 than the supporting projections 72a. As a result, the carrier 36, which in a basic position has two side faces parallel to one another, is slightly curved, with a radius of curvature in a range from 10 metres to approximately 50 metres.

Formed alongside the projection 66 on the frame 62 is a peripheral groove 74, which runs around parallel to the projection 66 and is therefore delimited on the one hand by the projection 66 and on the other hand by a second projection 76, projecting counter to the direction of gravitational force. The projection 76 projects somewhat further from a frame plate 78 of the frame 62 than the projection 66.

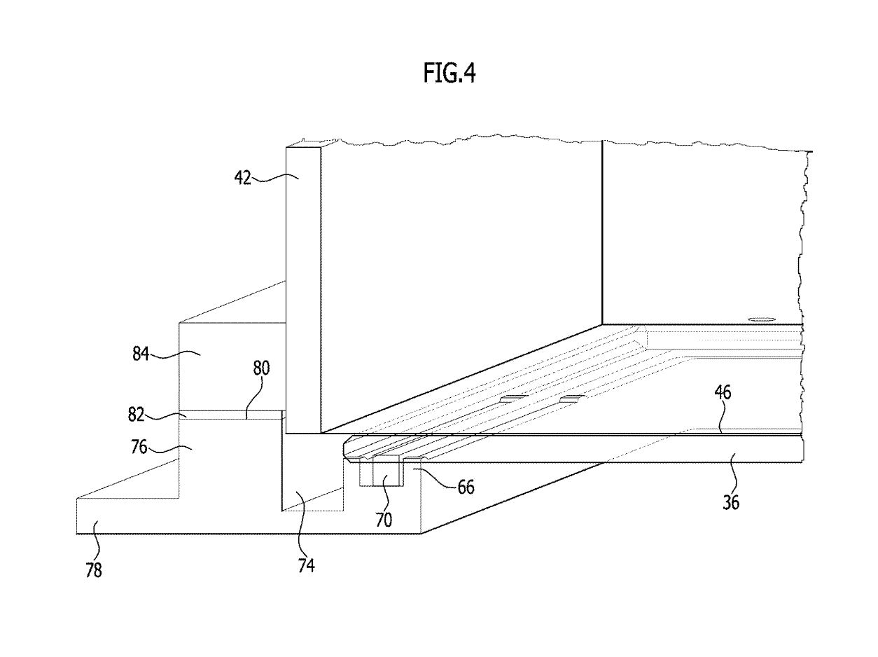

Arranged on an upper side 80 of the projection 76 and fixedly connected to the projection 76 is a peripheral sealing element 82. Resting on the sealing element 82 is a flange 84, which protrudes outwards from the frame 42 and surrounds the container 40 annularly. As can be seen well in FIG. 4, the release element 46 projects somewhat beyond the carrier 36 on all sides.

The groove 74 forms a fluid channel 86, which is consequently delimited by the frame 62, the sealing element 82, the frame 42, the release element 46 and the carrier 36. If, as described and illustrated by way of example in FIGS. 3 and 4, the container 40 is seated on the holding device, the fluid channel 86 is closed fluid-tightly. Furthermore, the release element 46 bears with surface-area contact against the curved reference surface 50, which is defined by the curved carrier 36.

In a way that is not illustrated in the Figures, the carrier 36 is clamped in the frame 62, in order to keep the sheet of glass 38 convexly curved. Alternatively, a sheet of glass 38 that already has the desired convex curvature may also be used.

In order to be able to use the advantages of the invention, it is already sufficient if the supporting projections 72b have a height that corresponds approximately to the thickness of 3 to 5 cured material layers of the object 12. This may be for example 0.3 to 0.5 mm.

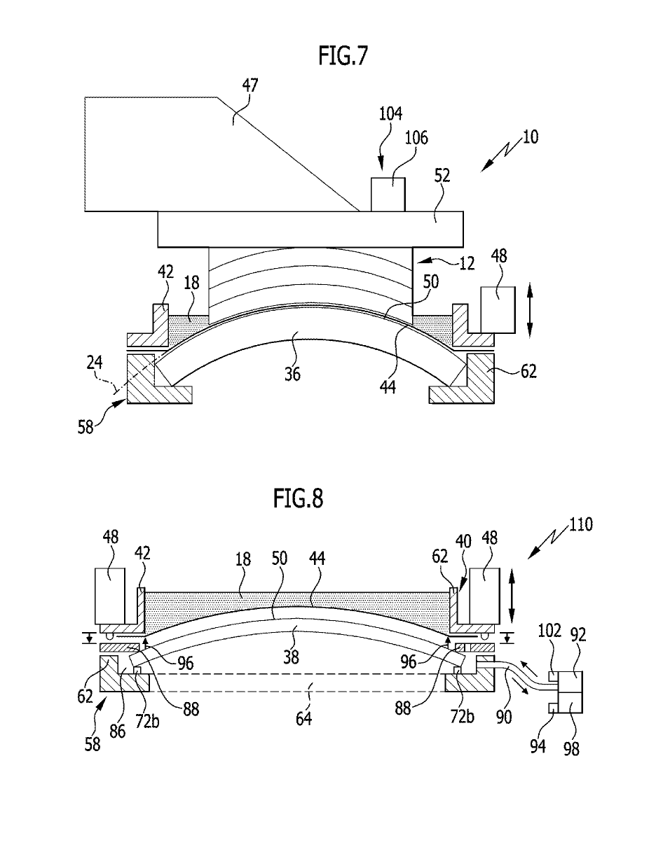

The forming of individual layers of the object 10 is explained in more detail below in conjunction with FIGS. 7 to 12. For the sake of overall clarity, the same designations as already above are used once again.

In FIG. 7, it is schematically illustrated in a greatly exaggerated manner in which position the release element 46 and the carrier 36 are located in the exposure position. The release element 46 bears against the carrier 36 with full surface-area contact. In a way that is not illustrated, a layer image is projected by the masking unit 26 into the image/building plane 24, which is defined by the curved upper side of the carrier 36.

If, as schematically illustrated in FIG. 7, the liquid material layer directly adjacent to the release element 46 is cured, it forms part of the object 12, but is still adhering to the release element 46.

In order that the next material layer of the object 12 can be cured, the already solidified part of the object 12 must be separated from the release element 46, in order that still liquid, non-solidified material 18 can flow between the last-solidified material layer and the release element 46.

Serving to facilitate the detachment of the release element 46 from the last-solidified material layer of the object 12 is a lifting device 48, which forms part of a release device 110 for releasing the solidified material layer adhering to the release element 46 and with which the container 40, and consequently also the release element 46 attached thereto, can be lifted off from the carrier 36. This is schematically illustrated in FIG. 8.

Also schematically depicted in FIG. 8 are the fluid channel 86 and two clamping elements 88 holding down the sheet of glass 38 at the edge in order to keep the upper side of the sheet of glass 38 curved as a reference surface 50.

In order to facilitate the detachment of the release element 46 from the carrier 36, the fluid channel 86 is connected fluidically to a fluid introduction device 92 by way of a connecting line 90. The fluid introduction device 92 may comprise in particular an venting valve 94. It may also take the form of a vacuum/pressure pump, in order to pump a gaseous or liquid release fluid, in particular air, into the fluid channel 86 or suck it away out of the latter.

If release fluid is introduced into the fluid channel 86, the release element 46 successively separates slowly from the outside into the middle, starting from the edge that is reached over by the carrier 36, symbolized in FIG. 8 by the two arrows 96. During this detaching operation, the container 40 may already be slowly lifted off from the holding device 58 by the lifting device 48, until the release element 46 and the carrier 36 are spaced completely from one another.

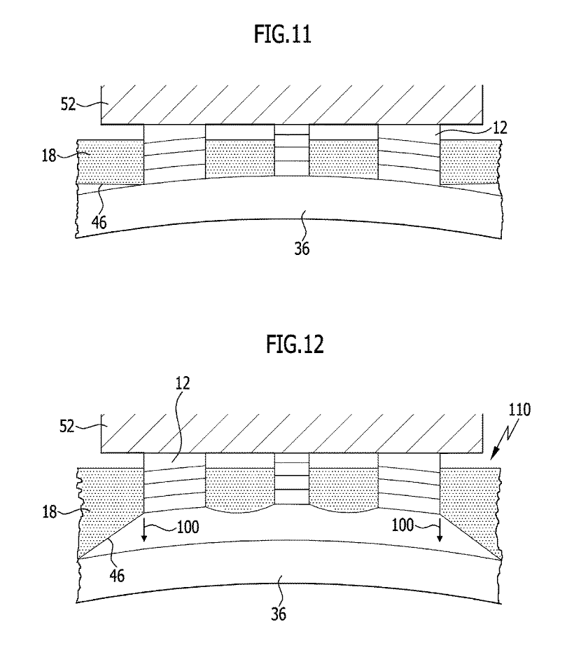

FIG. 11 shows schematically in section the situation of the release element 46 already partially detached from the carrier 36. However, it is still bearing against the carrier 36 in the region of the object 12.

It is schematically illustrated in FIG. 12 how, after the lifting off of the container 40 from the holding device 58, the release element 46, which is still adhering to the object 12, has been detached from the carrier 36.

In a next step, the release element 46 must then be released from the last-solidified material layer of the object 12. This may take place in particular by the platform 52 being pulled by the drive unit 54 further away from the release element 46, until the latter peels off from the object 12. However, in the case of this procedure, relatively high forces act on the release element 46 or the already solidified object 12. Moreover, relatively long displacements are required to detach the object 12 from the elastic and flexible release element 46.

In order to be able to accelerate the detaching operation and perform it as sensitively as possible, the release fluid between the release element 46 and the carrier 36 is removed, for example by pumping away, with a pumping device 98, which is connected fluidically to the fluid channel 86. The pumping device 98 may in particular be part of the fluid introduction device 92. By generating a negative pressure in the intermediate space between the release element 46 and the carrier 36, the release element 46 is successively peeled off from the already solidified object 12 from the outside, symbolized by the arrows 100.

A pressure measuring device 102, which may for example take the form of a pressure measuring sensor, can measure a pressure in the release fluid between the release element 46 and the carrier 36. Depending on the measured pressure, the pumping device 98 can be controlled in order to increase or reduce the negative pressure in such a way that damage to the already solidified object 12 and the release element 46 can be avoided.

Once the release element 46 has been released completely from the object 12, in a next step the container 40 can be lowered again. The release element 46 then first touches the carrier 36 substantially in the middle region, where it is curved the furthest towards the release element 46. If the container 40 is moved further in the direction of the holding device 58, the release element 46 gradually comes to bear snugly against the carrier 36 with full surface-area contact. Inclusions of air as a release fluid between the release element 46 and the carrier 36 can in this way already be avoided virtually completely.

In order to reduce further the risk of inclusions of air between the release element 46 and the carrier 36, the lowering of the container 40 with the lifting device 48 may be accompanied by the evacuation of the intermediate space between the release element 46 and the carrier 36. The pumping device 98, which is in connection fluidically with the intermediate space between the release element 46 and the carrier 36 by way of the connecting line 90 and the fluid channel 86, may once again be used for this purpose.

If required, the platform 52 may then be lowered to such an extent that a spacing between the last-solidified material layer of the object 12 and the release element 46 corresponds approximately to the thickness of the next material layer to be solidified. The not yet solidified material 18 can then flow into this gap between the object 12 and the release element 46. The system 10 is then prepared for the exposure of the next object layer.

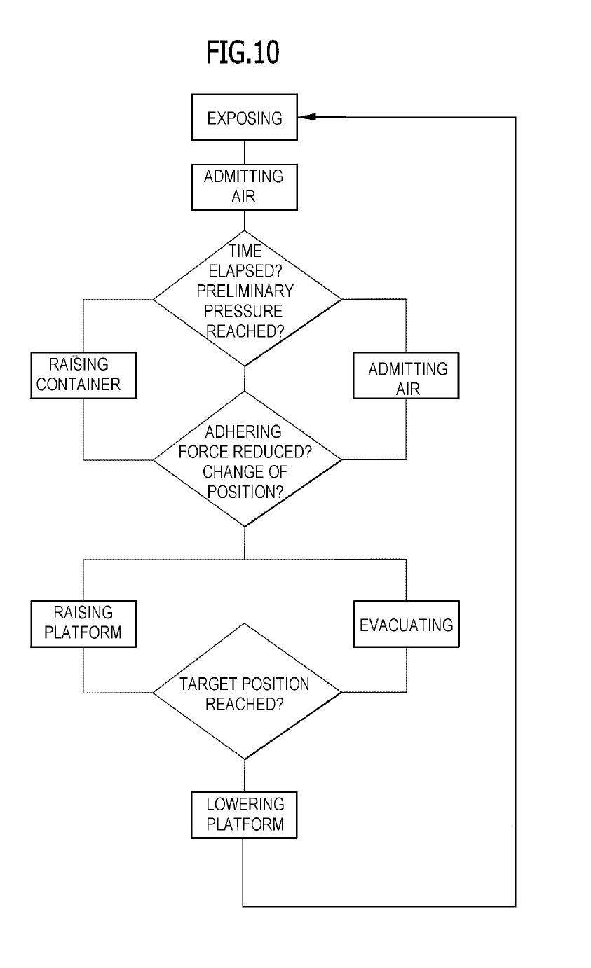

In FIG. 10, the sequence of the method for producing a three-dimensional object by solidifying layer by layer a material that can be solidified under the effect of radiation is schematically illustrated.

It begins at the top with the step of exposing the image/building plane 24 with an object layer image for the curing of a material layer corresponding to the object layer image of the object 12 to be produced.

After the preset exposure time has elapsed, release fluid is introduced between the release element 46 and the carrier 36 in an venting step. Once the exposure time and the preset pressure in the intermediate space between the release element 46 and the carrier 36, which can be measured for example with the pressure measuring device 102, have likewise been reached, the container 40 is raised away from the holding device 58 and further air is admitted.

If, while carrying out the method, the force acting on the platform 52 is measured, for example by way of a force measuring device 104 comprising a force measuring sensor 106, the container 40 is raised further and further air is admitted until a corresponding reduction in the adhering force, which is measured by the force measuring sensor 108, is established. Changes in the position of the platform 52 are also monitored. This means in particular that the container 40 is moved into a predefined relative position in relation to the holding device 58, so that the release element 46 and the carrier 38 are substantially at a defined spacing from one another. This corresponds substantially to the situation that is schematically illustrated in FIG. 12.

The described admission of air or venting may also be actively assisted by pumping in release fluid 92 between the release element 46 and the carrier 38 with the fluid introduction device. In this way, the detaching operation of the release element 46 from the carrier 36 can be accelerated.

As already described in conjunction with FIG. 12, for the separation of the release element 46 from the object 12, the platform 52 may then be raised, that is to say moved away somewhat from the carrier 36, and at the same time the intermediate space between the release element 46 and the carrier 36 evacuated by means of the pumping device 98. The release element 46 is then peeled off from the object 12 from the outside, beginning in the region of the arrows 100.

Once the target position of the platform 52 has been reached and the predefined pressure, which is measured with the pressure measuring device 102, has set itself, both the platform 52 and the container 40 may be lowered again, and as described so far, until the release element 46 bears again against the carrier 36 with large surface-area contact and the last-solidified material layer of the object 12 is at a spacing from the release element 46 that corresponds approximately to the thickness of a material layer to be solidified.

In the way described, all of the layers of the object 12 are solidified one after the other.

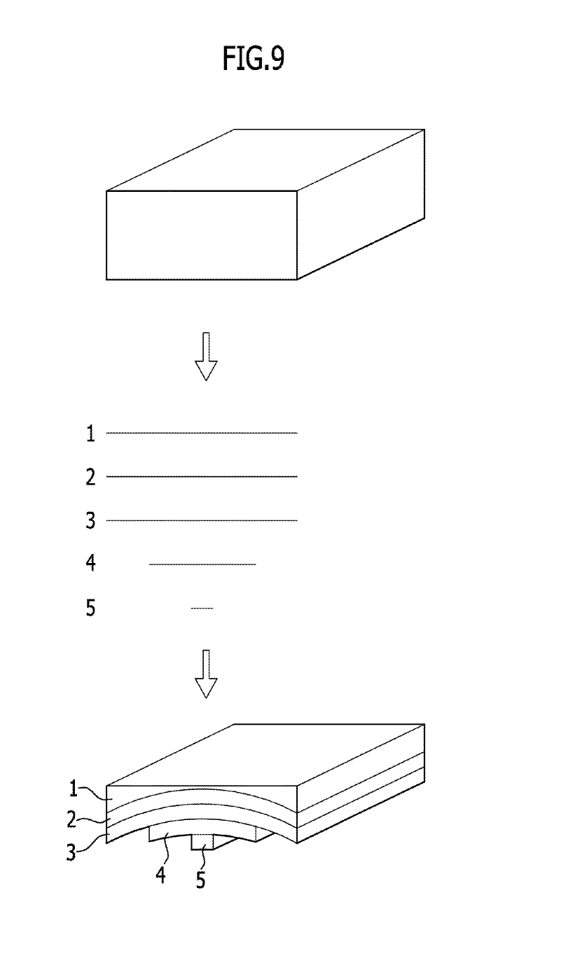

In FIG. 9 it is schematically illustrated how, taking into account the curved reference surface 50, an object 12 to be produced has to be broken down into corresponding material layers, and consequently into corresponding object layer images.

In order to form the cuboid that is schematically illustrated at the top in FIG. 9, the curvature of the carrier 36 must be taken into account. Consequently, the last layers that are solidified cannot be of the entire width of the cuboid, but must be narrower. Consequently, the last layers 4 and 5 to be solidified become narrower than the schematically illustrated first three layers of the object to be produced. The layer widths are schematically illustrated in the middle in FIG. 9. This then produces the layer structure schematically illustrated at the bottom in FIG. 9 for an object that has a substantially cuboidal shape.

The described system 10 and the described method for producing a three-dimensional object may be used for forming any desired objects, in particular from plastics. For example, moulds for dental technology may be produced, or in particular also devices adapted to a patient's body such as individually adapted hearing aid housings.

By the use of pressure and negative pressure with corresponding controls that use an open-loop and/or closed-loop control device schematically as depicted in FIG. 1, the forming of a material layer of the object 12 can be accelerated in comparison with conventional systems and methods. This is in particular because the detaching of the release element 46 from the already solidified part of the object 12 can take place significantly more quickly by evacuating the intermediate space between the release element 46 and the carrier 36. Moreover, the quality of the object 12 to be formed can be increased significantly, since the curved carriers 36 mean that no undesired inclusions of air or the like occur between the carrier 36 and the release element 46, and as described by the selective way in which the release element 46 is brought into contact with the furthest-projecting region of the carrier 36 and the selective way in which the release element 46 is sucked against the carrier 36 by evacuating the intermediate space between the same.

### LIST OF REFERENCE SIGNS

10 system
12 object
14 radiation field
16 radiation
18 solidifiable material
20 radiation source
22 imaging optical unit
24 image/building plane
26 masking unit
28 exposure mask generating device
30 memory device
32 computer
34 carrier system
36 carrier
38 sheet of glass
40 container
42 frame
44 bottom
46 release element
48 lifting device
50 reference surface
52 platform
54 drive unit
56 arrow
58 holding device
60 exchange unit
62 frame
64 window opening
66 projection
68 groove
70 sealing element
72a, 72b supporting projection
74 groove
76 projection
78 frame plate
80 upper side
82 sealing element
84 flange
86 fluid channel
88 clamping element
90 connecting line
92 fluid introduction device
94 venting valve
96 arrow
98 pumping device
100 arrow
102 pressure measuring device
104 force measuring device
106 force measuring sensor
108 open-loop and/or closed-loop control device
110 release device

What is claimed is:

1. System for producing a three-dimensional object by solidifying layer by layer a material that can be solidified under the effect of radiation, which system comprises a device for releasing a material layer of the solidifiable material that has solidified on a carrier defining a reference surface from the carrier, which device comprises a flexible elastic release element, which release element is arranged between the carrier and the material layer and can be detached nondestructively from the carrier, the system also comprising a fluid introduction device for introducing a release fluid between the carrier and the release element, wherein the reference surface is curved in a way deviating from a plane.

2. System according to claim 1, wherein the reference surface is curved one-dimensionally or two-dimensionally.

3. System according to claim 1, wherein at least one of
a) the reference surface defines a segment of a curved surface of a straight circular cylinder or a segment of an ellipsoid surface, in particular a spherical surface
and
b) the reference surface has a radius of curvature in a range from approximately 1 m to approximately 100 m, in particular in a range from approximately 10 m to approximately 50 m
and
c) the release element takes the form of a flexible elastic film
and
d) the film takes the form of a membrane
and
e) the system further comprises a container for the solidifiable material and the release element forms a bottom or part of a bottom or a top of the container
and
f) the container comprises a peripheral frame and the release element is arranged or formed on the frame.

4. System according to claim 1, characterized by a holding device for holding the carrier.

5. System according to claim 4, wherein the holding device comprises supporting projections of different heights for supporting the carrier.

6. System according to claim 4, wherein the holding device has a fluid channel, which is in particular formed peripherally.

7. System according to claim 6, wherein at least one of:
a) the fluid channel is closed fluid-tightly when, in an exposure position in which the solidifiable material is subjected to radiation, the release element bears against the carrier, in particular with full surface-area contact
and
b) at least one of the release element and the carrier define part of an inner delimiting surface of the fluid channel
and
c) the holding device defines part of an inner delimiting surface of the fluid channel
and
d) the frame defines part of an inner delimiting surface of the fluid channel.

8. System according to claim 1, wherein the release element projects beyond the carrier at least on one side, in particular on more than one side or on all sides.

9. System according to claim 4, wherein at least one of:
a) at least one first sealing element is arranged or formed between the carrier and the holding device
and
b) the system further comprises at least one second sealing element, arranged between the holding device and the frame
and
c) the second sealing element is arranged or formed on the holding device or on the frame.

10. System according to claim 1, wherein the carrier takes the form of a sheet of glass.

11. System according to claim 6, wherein the fluid introduction device is connected fluidically to the fluid channel.

12. System according to claim 1, wherein at least one of:
a) the system further comprises a pumping device for pumping away the release fluid between the release element and the carrier
and
b) the fluid introduction device is formed so as to introduce the release fluid between the release element and the carrier under positive pressure.

13. System according to claim 1, characterized by an venting device for introducing the release medium between the release element and the carrier.

14. System according to claim 13, wherein at least one of:
a) the venting device comprises at least one venting valve
and
b) the fluid introduction device comprises the venting device.

15. System according to claim 1, wherein the release fluid is a liquid or a gas, in particular water or air.

16. System according to claim 1, characterized by a lifting device for moving the release element and the carrier in relation to one another, in particular in a direction transverse, in particular perpendicular, to the reference surface.

17. System according to claim 16, wherein at least one of:
a) the lifting device is formed so as to raise and lower the release element
and
b) the lifting device is formed so as to raise and lower the frame.

18. System according to claim 1, further comprising at least one of:
a) a pressure measuring device for measuring a pressure prevailing between the release element and the carrier
and
b) a force measuring device, in particular a force measuring sensor, for measuring a force acting on the carrier.

19. System according to claim 1, characterized by an open-loop and/or closed-loop control device for controlling at least one of the fluid introduction device and the pumping device in an open-loop and/or closed-loop manner in dependence on at least one of a force acting on the carrier and in dependence on at least one of an exposure time and a curing time of the solidifiable material.

20. System according to claim 19, wherein at least one of:
a) the open-loop and/or closed-loop control device is formed so as to control the lifting device in dependence on the force acting on the carrier that is measured by the force measuring device
and
b) the open-loop and/or closed-loop control device is formed so as to control the lifting device in dependence on the pressure prevailing between the release element and the carrier.

21. System according to claim 1, characterized by an exposure device for exposing the solidifiable material layer by layer by subjecting it to radiation.

22. Method for producing a three-dimensional object by solidifying layer by layer a material that can be solidified under the effect of radiation, in which a material layer of the solidifiable material that has solidified on a carrier defining a reference surface is released from the carrier, a flexible elastic release element being arranged between the carrier and the material layer and being detached nondestructively from the carrier by introducing a release fluid between the carrier and the release element, wherein the reference surface is provided as a reference surface that is curved in a way deviating from a plane.

23. Method according to claim 22, wherein at least one of:
a) the reference surface is curved one-dimensionally or two-dimensionally
and
b) the release element takes the form of a flexible elastic film.

24. Method according to claim 22, wherein a container for the solidifiable material is provided and wherein the release element forms a bottom or part of a bottom or a top of the container.

25. Method according to claim 22, wherein the carrier is held on a holding device.

26. Method according to claim 25, wherein at least one of:
a) the carrier is placed onto supporting projections of the holding device, which differ in height, for supporting the carrier
and
b) the holding device is formed with a fluid channel, which is in particular formed peripherally.

27. Method according to claim 22, wherein a negative pressure is generated between the release element and the carrier.

28. Method according to claim 25, wherein at least one of:
a) the carrier and the holding device are sealed off in relation to one another
and
b) the holding device and the frame are sealed off in relation to one another.

29. Method according to claim 22, wherein at least one of:
a) the carrier is of a radiation-transmissive form, in particular in the form of a sheet of glass
and
b) to detach the release element from the carrier, release fluid is introduced under pressure between the release element and the carrier
and
c) the release fluid is conducted between the release element and the carrier by admitting air
and
d) the release fluid is provided in the form of a liquid or a gas, in particular in the form of water or air
and
e) for releasing them from one another and for bringing them into contact with one another, the release element and the carrier are moved in relation to one another, in particular in a direction transverse, in particular perpendicular, to the reference surface
and
f) the pressure prevailing between the release element and the carrier is measured
and
g) a force acting on the carrier is measured
and
h) the release fluid is introduced between the release element and the carrier in dependence on at least one of a force acting on the carrier and in dependence on at least one of an exposure time and a curing time of the solidifiable material
and
i) the release element and the carrier are moved in relation to one another in dependence on a force acting on the carrier
and
j) before the exposure of the solidifiable material to form a further cured material layer, the last-cured material layer is separated from the release element
and
k) an exposure device is provided for generating the radiation for exposing the solidifiable material layer by layer.
